(19) United States
(12) Patent Application Publication
(10) Pub. No.: US 2026/0169722 A1
(43) Pub. Date: Jun. 18, 2026

(54) SYSTEMS AND METHODS FOR AUTOMATING WEBSITE UPDATES BASED ON CHANGES TO TECHNICAL STANDARDS

(71) Applicant: ServiceNow, Inc., Santa Clara, CA (US)

(72) Inventor: Varun Kumar Jayanti, Telangana (IN)

(21) Appl. No.: 18/985,416

(22) Filed: Dec. 18, 2024

(51) Int. Cl. G06F 8/65

(52) U.S. Cl. CPC G06F 8/65

(57) ABSTRACT

A method includes receiving a set of rules associated with a technical standard, wherein the set of rules comprise an update to the technical standard and retrieving, from a code repository, a web code associated with a website. The method also includes identifying one or more portions of the web code that do not comply with at least one rule of the set of rules associated with the technical standard, updating the one or more portions of the web code to comply with the set of rules, and storing the one or more updated portions of the web code in the code repository.

### TECHNICAL FIELD

The present disclosure relates generally to a tool to support website maintenance and management. Specifically, the present disclosure relates to updating websites based on changes to technical standards.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Websites and corresponding web code (e.g., hypertext markup language (html) code, cascading style sheets (CSS), tags, etc.) are developed to provide information, foster engagement, and offer services of an enterprise. Websites may be initially designed based on technical standards such as search engine optimization (SEO) guidelines and web content accessibility guidelines (WCAG). However, technical standards are continuously updated to provide new guidelines enabling search engines to retrieve websites and increase web accessibility. However, there is no streamlined process for updating websites and corresponding web code based on updates to technical standards to increase relevance and accessibility of websites of the enterprise. For example, manual changes in coding of html tags, website structure, and/or additional technical changes may be used to maintain and/or improve SEO ranking of a website. Manual updates of websites and corresponding web code is an inefficient use of computing resources and organization user time. Accordingly, new techniques for maintaining compliance with technical standards are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A tool is disclosed herein that enables streamlined maintenance and management by providing updates and management of websites and web code based on changes in technical standards. The tool may automatically perform a workflow to support website maintenance and management of one or more portions of code based on changes and/or updates of technical standard guidelines. In this manner, the tool may identify portions of code of a website associated with changes in technical standard guidelines and subsequently update the identified portions of code. Further, the tool may streamline automatic updates based on changes and/or updates to technical standards when compared to previously available manual based techniques.

In certain aspects, the present disclosure is generally directed to a method including receiving a set of rules associated with a technical standard, wherein the set of rules include an update to the technical standard and retrieving, from a code repository, a web code associated with a website. The method also includes identifying one or more portions of the web code that do not comply with at least one rule of the set of rules associated with the technical standard, updating the one or more portions of the web code to comply with the set of rules, and storing the one or more updated portions of the web code in the code repository.

The present disclosure is also directed to a system including processing circuitry and memory, accessible by the processing circuitry, the memory storing instructions that, when executed by the processing circuitry, cause the processing circuitry to perform operations. The operations include receiving a set of rules associated with a technical standard, which may include an update to the technical standard, and retrieving, from a code repository, a web code associated with a website. The operations also including identifying one or more portions of the web code that do not comply with at least one rule of the set of rules associated with the technical standard, updating the one or more portions of the web code to comply with the set of rules, and storing the one or more updated portions of the web code in the code repository.

The present disclosure is further directed to a non-transitory computer-readable storage medium including processor-executable routines that, when executed by a processor, cause the processor to perform operations. The operations include receiving a set of rules associated with a technical standard, which may include an update to the technical standard, and retrieving, from a code repository, a web code associated with a website. The operations also include identifying one or more portions of the web code that do not comply with at least one rule of the set of rules associated with the technical standard, updating the one or more portions of the web code to comply with the set of rules, and storing the one or more updated portions of the web code in the code repository.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating an embodiment in which a virtual server, which supports and enables the client instance, hosts a website management tool, in accordance with aspects of the present techniques;

FIG. 5 is a schematic embodiment of the website management tool of FIG. 4 to be utilized within an enterprise, in accordance with aspects of the present techniques;

FIG. 6 is a schematic embodiment of a user interface of the website management tool of FIG. 4 and FIG. 5, in accordance with aspects of the present techniques;

FIG. 7 is a flow chart of a process for updating rules based on changes to technical standards, in accordance with aspects of the present techniques; and

FIG. 8 is a flow chart of a process for updating a website based on the changes to the technical standards of FIG. 7, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As discussed above, technical standards may be updated impacting relevance and accessibility of websites and corresponding web code of an enterprise. For example, in some instances outdated websites offered by the enterprise may experience a decrease in web-based traffic due to lack in compliance with SEO guidelines. That is, websites with updated web code may be ranked higher in search engine query results as compared to outdated websites. As such, there is a need to provide streamlined updates to websites of the enterprise to provide searchable websites.

Accordingly, the presently disclosed techniques may be used to improve techniques for maintaining and managing software products of an enterprise. A website management tool is disclosed herein to streamline updates and management of websites and web code based on changes in technical standards (e.g., SEO guidelines, WCAG, etc.). The website management tool may automatically perform a workflow to support website maintenance and management of one or more portions of code based on changes and/or updates of technical standard guidelines. In this manner, the website management tool may identify portions of a code within a web code of a website of an enterprise associated with changes in technical standard guidelines and subsequently update the identified portions of code. In some implementations the updated code must be approved/accepted before being deployed within the web code of the website. For example, the website management tool is configured to receive coding guidelines generated based on updates to technical guidelines, extract source code of the website, and generate compliant (e.g., SEO compliant, WCA compliant, etc.) code. The website management tool may update metadata, html codes, CSS, tags, and the like of the website based on the coding guidelines. The website management tool may automatically manage and maintain websites using a rule-based program. The rule-based program may access a portion of a code (e.g., html code, CSS, website structure, content text, source code) used in development and usage of websites. The rule-based program may include one or more rules generated to convert portions of code to comply with updated technical guidelines. The one or more rules may be managed by operational users and applied to a plurality of websites operated by an enterprise to enable streamlined compliance updates. For example, correction and/or update of the portion of code may be implemented via the rules-based system to automatically support implementation of modified technical standards to maintain reliability of websites across the enterprise. Additionally, present embodiments include a graphical user interface (GUI) designed to present the website management tool in a concise and organized format, which enables streamlining of website development and management into existing development platforms of the enterprise.

In some embodiments, the website management tool may provide one or more versions of technical standards and/or one or more corresponding sets of rules. In this way, the website management tool may be used across a series of platforms with one or more different technical standard requirements. For example, a first browser may have a first set of SEO guidelines while a second browser may have a second set of SEO guidelines. In this manner, the website management tool may apply a first set of rules to convert portions of code to comply with the first browser and a second set of rules to convert portions of code to comply with the second browser. Accordingly, the presently disclosed techniques may be used to improve techniques for managing various versions of software products of the enterprise.

Use of the disclosed techniques enables management and maintenance of software products of the enterprise by providing automatic updates to portions of web code impacted by changes to technical standards. Accordingly, using the disclosed techniques, up to date software products such as websites of the enterprise may be provided to users of the enterprise, improving reliability and/or functionality of products provided by the enterprise. As a result, use of the disclosed techniques may reduce computational costs and organization user time associated with manually updating web code associated with websites of the enterprise.

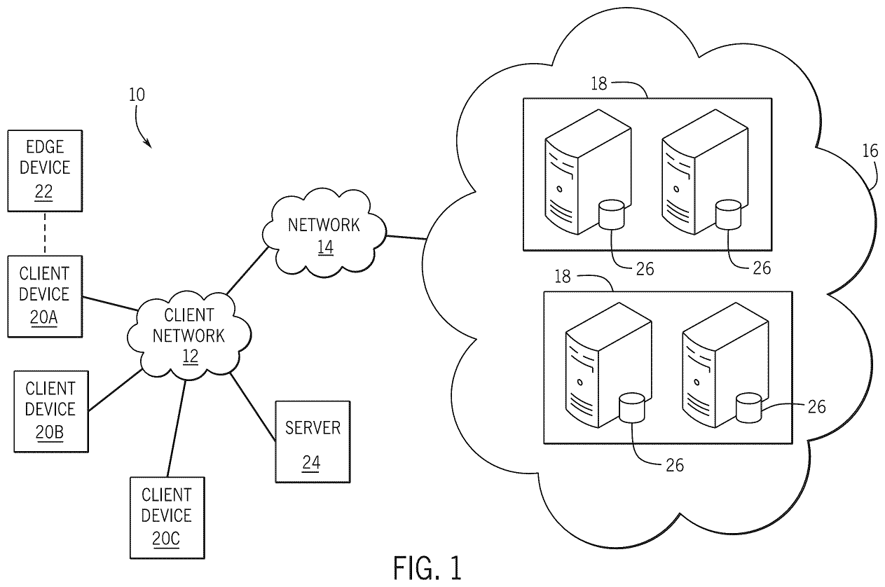

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform in which hardware, software, and/or other aspects of the client network 12 and/or cloud-based platform are regularly tracked and monitored. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

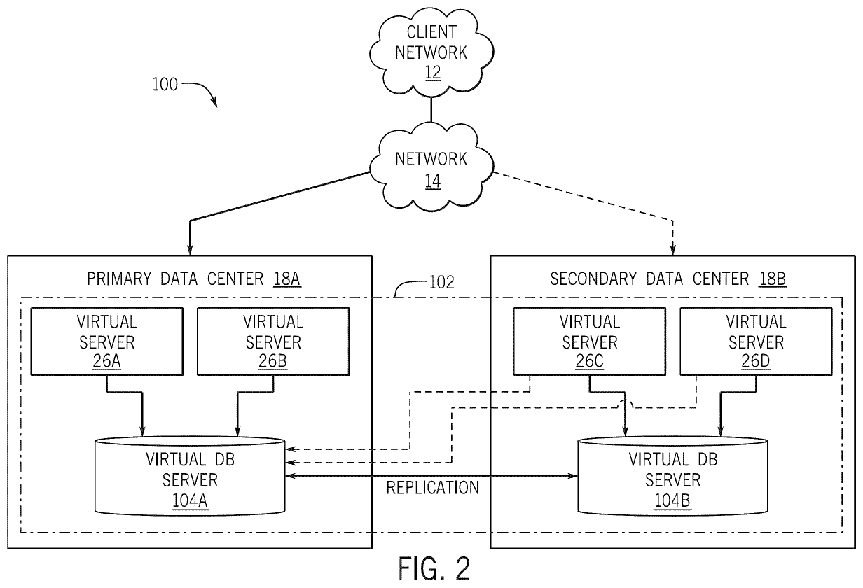

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

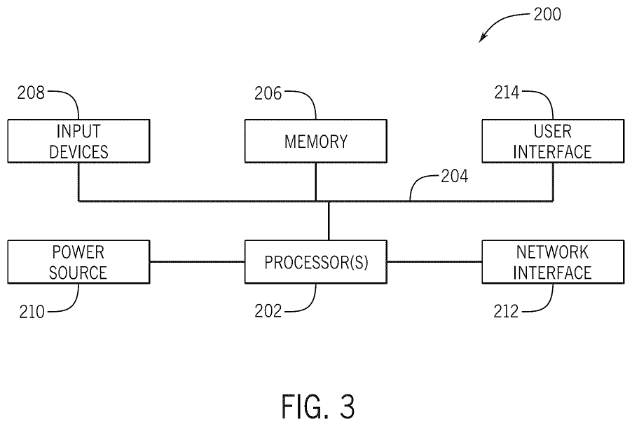

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

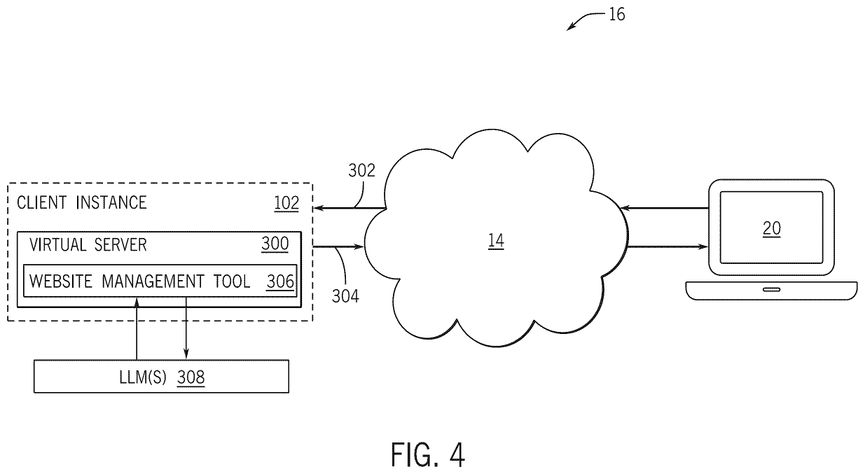

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 300 similar to the virtual servers 26 explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 302, to which the client instance 102 may respond with outputs 304. In the embodiment shown in FIG. 4, the virtual servers 300 of the client instance 120 may run a website management tool 306, which may be a software application or script defined by code, accessible via a native application or web browser of the client device 20. Accordingly, the inputs 302 may include inputs requesting updating portions of code based on changes to technical standards, and so forth. In some embodiments, the website management tool 306 may be hosted by the client instance 102. In some embodiments, one or more LLMs 308 may be external to the client instance 102, but accessible by the client instance 102. In other embodiments, the LLMs 308 may be hosted by the client instance 102 (e.g., the LLMs 308 may be local and/or private instantiations of an LLM). The website management tool 306 may be used to process changes to technical standards, generate sets of rules, execute compliance testing, and update portions of code of the enterprise. The LLMs 308 may be used to generate one or more technical standard definitions, generate rule sets, and the like. The client instance 102 hosting the website management tool 306 may be accessible via the client device 20. In this manner, the website management tool 306 may automatically identify updates to technical standards associated with websites and/or applications of the enterprise within the cloud provide infrastructures of the enterprise.

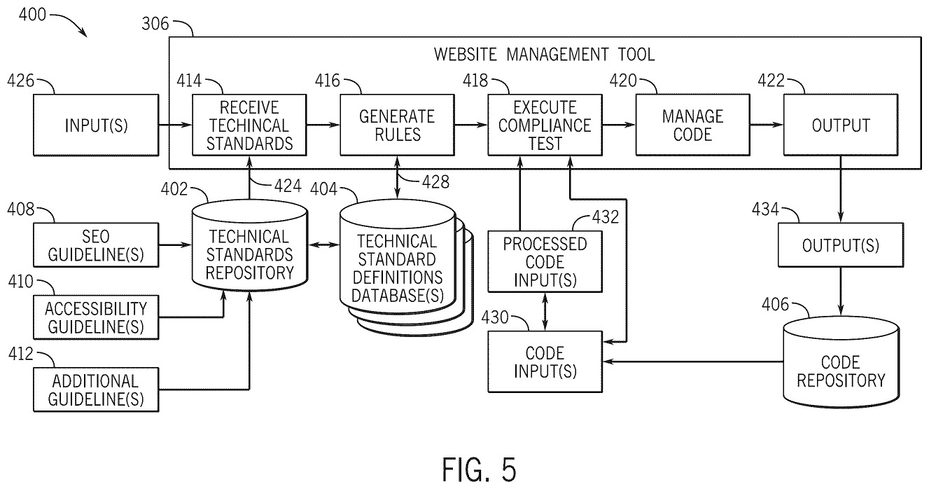

With this in mind, FIG. 5 is a schematic illustrating a portion of a development platform 400 to be utilized within an enterprise. The development platform 400 includes the website management tool 306 of FIG. 4, which may be used to support software development of one or more portions of web code impacted by changes to technical standards. The website management tool 306 may be executed from the platform 16 of the enterprise. As such, the website management tool 306 may be embedded within the platform 16 of the enterprise. For example, the website management tool 306 may be accessible via a client device. Specifically, the client device may be configured to display a graphical user interface (GUI) that displays information and receives inputs that command the website management tool 306 to take certain actions to update the portions of web code impacted by changes to technical standards. The website management tool 306 streamlines version control, updates, and maintenance of web code across the enterprise within a single development platform.

In some embodiments, the development platform 400 may include a technical standards repository 402, one or more technical standard definitions databases 404, a code repository 406, and one or more additional repository and/or database. The technical standards repository 402 may include a listing of one or more SEO guidelines 408, one or more accessibility guidelines 410 (e.g., WCAG), and/or one or more additional guidelines 412. The one or more additional guidelines 412 may include one or more data privacy and collection guidelines (e.g., GDPR, CCPA, etc.), one or more cookie guidelines, one or more data security guidelines, one or more content licensing and attribution guidelines, and the like. In some embodiments, the technical standards repository 402 may include a listing of SEO guidelines such as guidelines relating to titles, meta descriptions, header tags, URL structure, keywork relevance, internal linking, load times, page speed, backlinks, and the like. The SEO guidelines 408, the accessibility guidelines 410, and/or the additional guidelines 412 may be provided as inputs to the technical standards repository 402. As such, the SEO guidelines 408, the accessibility guidelines 410, and/or the additional guidelines 412 may be updated by one or more third-parties and provided to the development platform 400. In some cases, one or more versions of respective guidelines may be stored in the technical standards repository 402.

In certain embodiments, one or more technical standard definitions may be generated from the technical standards repository 402 and stored in the technical standard definitions database 404. The technical standard definitions may include one or more templates related to updates and/or changes to technical standards stored in the technical standards repository 402. For example, the technical standard definitions may include a template for a title tag to be used within a portion of code (e.g., html code) of a website. The template may include <title>MAINTITLE: DESCRIPTIVE TITLE-SOURCE</title>. As such, the technical standard definitions database 404 may store definitions that may be used by the website management tool 306 to generate one or more sets of rules to apply to web code stored in the code repository 406 associated with the enterprise. It should be noted, in some embodiments, the technical standards repository 402, the technical standard definitions database 404, and the code repository 406 may be included with the website management tool 306.

As shown, the website management tool 306 may include one or more stages. It should be noted that the illustrated stages are provided as examples and more, fewer, or different stages may be included in the website management tool 306. As shown, the website management tool 306 may include an input stage 414, a rules generation stage 416, a compliance test stage 418, a management stage 420, and an output stage 422. The input stage 414 is initiated upon receiving one or more technical standards 424 from the technical standards repository 402, one or more inputs 426 from an organization user, or a combination thereof. The technical standards 424 may include updates and/or changes to the SEO guidelines 408, the accessibility guidelines 410, and/or the additional guidelines 412. The inputs 426 may include one or more updates deployed by the enterprise based on updates to internal guidelines, legal standards, one or more changes in content offerings, and the like. The technical standards 424 and/or the inputs 426 may be acquired by the website management tool 306 during the input stage 414 based on a request from the website management tool 306, automatic delivery, triggered delivery (e.g., time based, threshold based), manual intervention, and the like.

In some embodiments, the input stage 414 is advanced to the rules generation stage 416 based on receiving the technical standards 424 and/or the inputs 426. The rules generation stage 416 may access and/or receive the technical standard definitions database 404 to receive one or more technical standard definitions 428. The technical standard definitions 428 may be assessed using a rule-based program or routine configured to generate one or more sets of rules. For example, accessibility guidelines 410 may include standards related to a target size for clickable elements on a website. In this manner, the technical standard definitions 428 may include a number of CSS pixels related to the target size (e.g., 24×24 CSS pixels, 44×44 CSS pixels, and the like). As such, the rules generation stage 416 may generate a first set of rules related to the target size. The first set of rules may include a rule to increase the target size to 44×44 CSS pixels for clickable elements on the website currently less than 44×44 CSS pixels. Additionally and/or alternatively, the rule generation stage 416 may generate a second set of rules related to a structure of header tags used to indicate hierarchy of the website. The technical standard definitions 428 may include a definition related to the structure of header tags such as words in an URL of a website may be replicated with structured data in the header tags of the website. As such, the second set of rules may include a rule to generate structured data related to words in the URL of the website. It should be noted, one or more additional sets of rules are envisioned for generation and use by the website management tool 306. The sets of rules may be generated automatically by the website management tool 306. In some embodiments, the sets of rules may be analyzed by organizational users of the enterprise to ensure compliance with the technical standards 424, inputs 426, compatibility with programming languages, and the like.

In some embodiments, the rules generation stage 416 is advanced to the compliance test stage 418 based on generating the one or more sets of rules. The compliance test stage 418 may receive one or more code inputs 430, one or more processed code inputs 432, or a combination thereof. The code inputs 430 may include one or more portions of code generated during building, testing, and/or deployment or a website and/or application of the enterprise. The code inputs 430 may be retrieved from the code repository 406. The code repository 406 may include portions of web code associated with websites and/or applications of the enterprise. The code inputs 430 may be automatically accessed and/or received during execution of the compliance test stage 418 of the website management tool 306. The processed code inputs 432 may include one or more tags to indicate to the website management tool 306 a particular use case and/or a version associated with the code inputs 430. For example, the processed code inputs 432 may include a portion of code from the website of the enterprise and an associated web browser in which the website operates. The tags included in the processed code inputs may be based on metadata associated with the code inputs 430, a particular browser in which the website code is based, a type of website the portion of code is retrieved from, and the like. In this manner, the processed code inputs 432 may be retrieved by the compliance test stage 418 and the one or more tags may be analyzed by the website management tool 306 in order to apply a particular set of rules generated by the rule generation stage 416. With this in mind, it should be noted, a subset of the set of rules may be applied to the code inputs 430, the processed code inputs 432, or a combination thereof received at the compliance test stage 418.

In some embodiments, the compliance test stage 418 may identify one or more portions of code of the received code inputs 430 and/or processed code inputs 432 that do not comply with at least one rule of the set of rules associated with the technical standard. The one or more portions of code may be flagged by the website management tool 306. For example, the target size associated with a clickable element on the website may be flagged as being less than 44×44 CSS pixels based on the first set of rules discussed above. Additionally and/or alternatively, the structure of header tags may be flagged based on the website not including structured data relating to words listed in the URL of the website based on the second set of rules discussed above. As such, one or more portions of the code associated with the website of the enterprise may be flagged.

In some embodiments, the compliance test stage 418 is advanced to the management stage 420 based on flagging one or more portions of code. The management stage 420 may be used to update the one or more portions of code flagged during the compliance test stage 418. The one or more portions of code may be automatically updated by the website management tool 306. The management stage 420 may be used to update the code inputs 430 and/or the processed code inputs 432 to comply with the technical standards 424. The management stage 420 may apply the set of rules to the flagged portions of the code of the website. For example, the target size associated with the clickable element on the website may be updated to a size equal to or greater than 44×44 CSS pixels. Additionally and/or alternatively, the structure of header tags may be updated to include structured data relating to words listed in the URL of the website. In some embodiments, a template associated with a title tag may be updated in a portion of code (e.g., html code) of a website. The template may include <title>MAINTITLE: DESCRIPTIVE TITLE-SOURCE</title>. As such, the updated portion of code may be formatted to include a main title, a descriptive title, and a source. For example, the main title may be updated to include “FAQs related to Customer Relationship Management (CRM),” the descriptive title may include “Answers to common organizational questions related to cloud-based CRM including SaaS implementation,” and the source may include “The Enterprise.” Further, a particular flagged portion of code may be flagged to update obtaining consent from users regarding storing data associated with cookies used within the website. As such, the particular flagged portion of code may be updated to embed a prompt to notify the user of cookies used within a portion of the website corresponding to the flagged portion of code. In this manner, the management stage 420 may generate one or more updated portions of code. The updated portions of code may provide searchable and/or accessible access to content provided on websites of the enterprise.

In some embodiments, the management stage 420 is advanced to the output stage 422 based on generating the one or more updated portions of code. In some embodiments, the output stage 422 may provide one or more outputs 434 to the code repository 406. The outputs 434 may include the one or more updated portions of code. As such, the web code stored in the code repository 406 may be updated. In certain embodiments, providing the outputs 434 to the code repository 406 may automatically update the code associated with the website of the enterprise. As such, the website of the enterprise may comply with the technical standards 424 (e.g., updates to the technical standards, changes to the technical standards, and the like). In some embodiments, the output stage 422 may include a reviewing step. The reviewing stage may include providing the updated portions of code received from the management stage 420 to an organizational user of the enterprise for review. The organizational user may review the updated portions of code and may generate one or more outputs 434. In some cases, the outputs 434 generated by the organizational user may include edits to the updated portions of code generated by the website management tool 306.

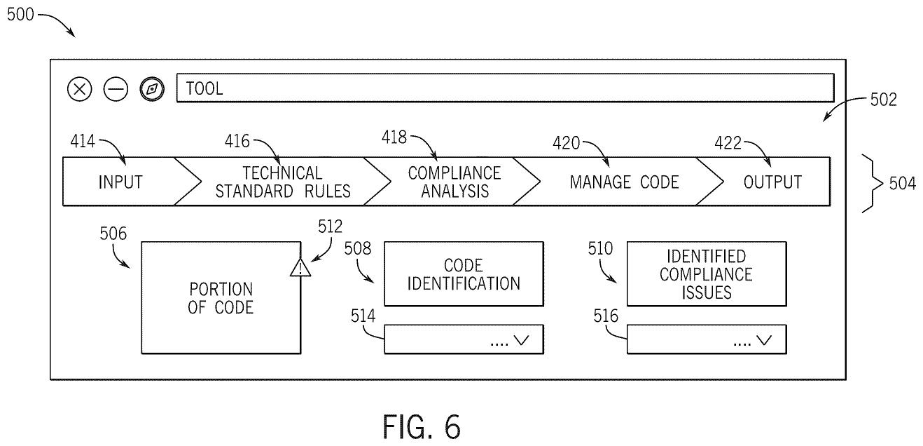

FIG. 6 is a schematic embodiment of a user interface 500 of the website management tool 306. The user interface 500 may display a screen having a dashboard 502 (e.g., command center) that may be used to identify programming languages within the development platform 400. In this manner, the website management tool 306 provides centralized feedback to one or more users of the dashboard 502. The dashboard 502 may include various widgets (e.g., user interface widgets) providing alerts, notifications, status updates, user requests, value assessments and the like. Further, the website management tool 306 may be used to direct various stages (e.g., the input stage 414, the rules generation stage 416, the compliance test stage 418, the management stage 420, the output stage 422) as discussed above with reference to FIG. 5.

In some embodiments, the various widgets of the dashboard 502 include one or more of a status bar widget 504, a code input widget 506, a code identification widget 508, and a compliance widget 510. The status bar widget 504 may display a plurality of stages of the website management tool 306. Each stage of the website management tool 306 may be selected to generate a page of the user interface 500. In some instances, selection of a particular stage may generate a dialog box within the user interface 500. In the illustrated embodiment, the compliance test stage 418 is selected. In this manner, the code input widget 506, the code identification widget 508, and the compliance widget 510 are displayed. In certain embodiments, the code input widget 506 may include a portion of code. The portion of code may be acquired as the code inputs 430 and/or the processed code inputs 432 from the code repository 406. In some embodiments, the code inputs 430 and/or the processed code inputs 432 may be directly acquired via the user interface 500. That is, the organizational user may input the portion of code, a file path to the portion of code, and/or an additional reference to the portion of code via the code input widget 506. As shown, the code input widget 506 may include one or more notification icons 512 indicative of an error, a missing file path, missing parts, and the like for a particular portion of code. For example, notifications related to the particular portion of code may be displayed to the user on the dashboard 502 upon selection of the notification icon 512 indicating that a file path input to the code input widget 506 may not be found.

The code identification widget 508 may include one or more tags associated with the processed code inputs 432. For example, the code identification widget 508 may include a version of the technical standards associated with a particular set of rules to be applied to the processed code inputs 432. In some embodiments, the code identification widget may receive one or more inputs 514 from the organizational user via the dashboard 502 of the user interface 500. The compliance widget 510 may provide the organizational user with one or more listings based on one or more portions of code flagged and/or identified as not in compliance with at least one rule of the set of rules associated with the technical standards 424. For example, in some embodiments, the website management tool 306 may identify one or more portions of code related to html tags, website structure, accessibility features and/or additional technical changes recommended by the website management tool 306. One or more inputs 516 may be provided by the organizational user via the user interface 500 for review. In some embodiments, the user interface 500 may be used by the organizational user to review the flagged portions of code identified as having compliance issues via the compliance widget 510. In this manner, the organizational user may provide external review to ensure that the website management tool 306 identifies and flags portions of the code of the website impacted by changes to technical standards. It should be noted, in some embodiments, the website management tool 306 may operate automatically without review by the organizational user.

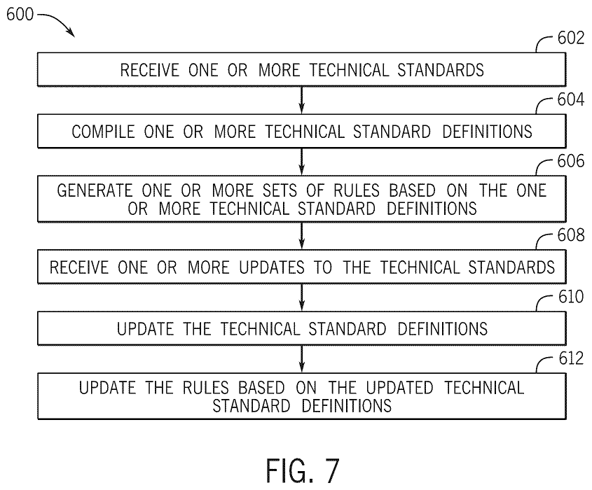

Referring now to FIG. 7, which depicts a process 600 for generating and updating rules based on one or more technical standards. The process 600 may be performed by the client device 20, a computing device or controller disclosed above with reference to FIG. 1 or any suitable computing device(s) or controller(s). Furthermore, the blocks of the process 600 may be performed in the order disclosed herein or in any suitable order. For example, certain blocks of the process may be performed concurrently. In addition, in certain embodiments, at least one of the blocks of the process 600 may be omitted.

At block 602 of the process 600, the website management tool 306 may receive one or more technical standards. The one or more technical standards may include the one or more SEO guidelines 408, the one or more accessibility guidelines 410 (e.g., WCAG), the and/or one or more additional guidelines 412. The one or more additional guidelines 412 may include one or more data privacy and collection guidelines (e.g., GDPR, CCPA, etc.), one or more cookie guidelines, one or more data security guidelines, one or more content licensing and attribution guidelines, and the like. The technical standards may be updated and/or changed based on one or more new versions of a particular technical standard, one or more changes to an existing version of the particular technical standard, and the like.

At block 604 of the process 600, the website management tool 306 may compile one or more technical standard definitions. The one or more technical standard definitions may include one or more templates related to updates and/or changes to the technical standards 424 stored in the technical standards repository 402, one or more parameters associated with the technical standards 424, and the like. In some embodiments, the website management tool 306 may generate the technical standard definitions by associating the particular features of each technical standard with a portion of executable code. In some embodiments, the technical standard definitions may be stored in the technical standard definitions database 404. For example, the technical standard definitions may include various definitions related to a new version of a technical standard. The new version of the technical standard may include a portion of text related to applying technical standards to websites. The portion of text may be associated with a load speed of the website. As such, the website management tool 306 may generate a particular technical standard definition related to the load speed of the website by analyzing the portion of text and outputting the definition such as “load speed less than or equal to three seconds.” In some embodiments, an LLM 308 may be used to generate the technical standard definitions. For example, the LLM 308 may analyze the portion of text and output one or more technical standard definitions based on machine learning analysis.

At block 606 of the process 600, the website management tool 306 may generate one or more sets of rules based on the one or more technical standard definitions. The one or more sets of rules may include rules to apply to code inputs from the website associated with the enterprise. The one or more sets of rules may include a particular rule associated with the load speed of the website. For example, the particular rule may include directions for the website management tool 306 to flag a webpage when the load speed is greater than or equal to three seconds. It should be noted that one or more rules may be included in the set of rules generated by the website management tool 306. Additionally and/or alternatively, the website management tool 306 may generate sets of rules associated with versions of technical standards. In this manner, the sets of rules may be applied to update code associated with the website of the enterprise based on browser requirements, ADA requirements, and the like.

At block 608 of the process 600, the website management tool 306 may receive one or more updates to the technical standards. In some embodiments, the technical standards may be dynamically updated by one or more third-parties, one or more organizational users, and the like. As such, it may be advantageous for the website management tool 306 to enable dynamic updates to the technical standards, portions of the technical standards, and the like. In this manner, the website management tool 306 may automatically receive one or more updates to the technical standards such as new SEO guidelines, changes to WCAGs, updates to data privacy guidelines, and the like. Accordingly, as compared with previous techniques, receiving updates to the technical standards may reduce organizational user time associated with updating web code across websites of the enterprise.

At block 610 of the process 600, the website management tool 306 may update the technical standard definitions. The technical standard definitions may be updated via generation of new technical standard definitions, replacement of one or more existing technical standard definitions, or a combination thereof. Updates to the technical standard definitions may be stored in the technical standard definitions database 404. At block 612 of the process 600, the website management tool 306 may update the one or more sets of rules based on the updated technical standard definitions. The website management tool 306 may automatically update the sets of rules based on the updated technical standard definitions. For example, a particular updated technical standard definition may include a change to image quality associated with images embedded within the website of the enterprise. The change to image quality may require images to have a standard file size to facilitate improved loading speeds. As such, the website management tool 306 may update a set of rules related to image quality. The set of rules may be updated to include a rule directed to images having the standard file size associated with the particular updated technical standard definition. As such, the website management tool 306 may be used to dynamically update code related to websites using up-to-date technical standard definitions. Such automation may improve operational efficiency of the website and/or improve access to the website based on searchability and/or accessibility.

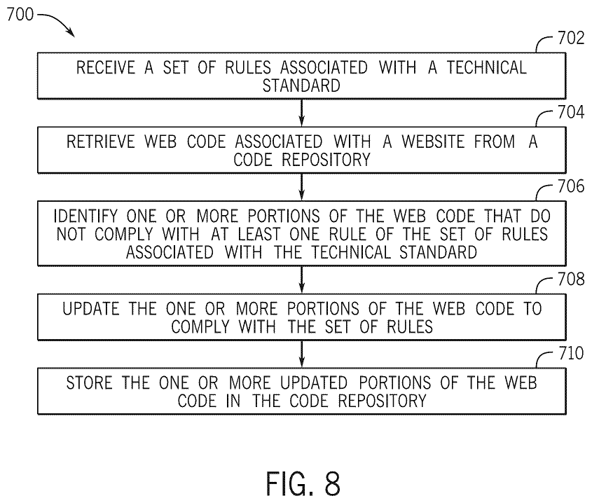

Referring now to FIG. 8, a website management tool 306 may perform a process 700 for updating and storing portions of web code based on rules associated with technical standards. The process 700 may be performed by the client device 20, a computing device or controller disclosed above with reference to FIG. 1 or any 700 suitable computing device(s) or controller(s). Furthermore, the blocks of the process 700 may be performed in the order disclosed herein or in any suitable order. For example, certain blocks of the process may be performed concurrently. In addition, in certain embodiments, at least one of the blocks of the process 700 may be omitted.

At block 702 of the process 700, the website management tool 306 may receive a set of rules associated with a technical standard. The set of rules may include rules generated based on technical standard definitions. In some embodiments, the set of rules may be associated with a particular version of a technical standard. The set of rules may include if-then statements that may be used to analyze features within code of the website of the enterprise. The set of rules may include combination of conditions that may be applied based on interrelated hierarchical dependencies. The set of rules may include a rule-based machine learning model that may be automatically defined based on analysis of the technical standard and/or technical standard definitions.

At block 704 of the process 700, the website management tool 306 may retrieve web code associated with a website from a code repository. The web code may be associated with a particular web page of the website of an enterprise. The web code may be stored in the code repository associated with the enterprise. In some embodiments, various versions of the web code may be stored in and/or retrieved from the code repository. The various versions of the web code may be associated with a particular browser and/or platform used to display the web code via the website. As such, the various versions of the web code may include metadata related to the particular browser and/or a particular technical standard associated with display of the web code on the website.

At block 706 of the process 700, the website management tool 306 may identify one or more portions of the web code that do not comply with at least one rule of the set of rules associated with the technical standard. The one or more portions of the web code may be identified as non-compliant based on not satisfying conditions of at least one rule of the set of rules. For example, a particular rule of the set of rules may be directed to descriptions of an animation and/or a video embedded within the website. The particular rule may establish that the animation and/or the video includes a short label describing content presented and a longer description describing each frame of the animation and/or the video. As such, the website management tool 306 may determine that the particular rule is not satisfied in a particular portion of the web code. As such the particular portion of the web code may be flagged by the website management tool 306 as non-compliant.

At block 708 of the process 700, the website management tool 306 may update the one or more portions of the web code to comply with the set of rules. The identified (e.g., flagged) portions of the web code may be updated automatically be the website management tool 306. As such, the website management tool 306 may update the web code to provide compliance with the technical standard. In some embodiments, the tool 306 may update the web code using AI technologies. For example, the portions of the web code may be provided to a machine learning model, a neural network, a LLM, and the like to be updated. In certain embodiments, the website management tool 306 may update the portions of the web code based on applying the set of rules. Additionally and/or alternatively, the website management tool 306 may update the one or more portions of the web code by incorporating feedback from an organizational user.

At block 710 of the process 700, the tool 306 may store the one or more updated portions of the web code in the code repository. The website management tool 306 may output the updated portions of the web code to the code repository. The updated portions of the web code may replace one or more previous versions of the web code. In some embodiments, the updated portions of the web code may be stored as a new version of the web code. The updated portions of the web code may be displayed via the website of the enterprise. As such, the website of the enterprise may automatically be updated based on changes to technical standards. In this manner, relevancy, searchability, and/or accessibility of the website of the enterprise may be improved. The disclosed techniques result in better management of web code compliance with technical standards impacting performance of websites of the enterprise, which improves end user experiences of cloud computing services offered by the enterprise.

Technical effects of the disclosed techniques include use of a website management tool 306 to provide continuous updates to web code associated with websites of the enterprise to enable search engines to retrieve websites and increase web accessibility. The website management tool 306 may include various stages such as an input stage 414, a rules generation stage 416, a compliance test stage 418, a management stage 420, and an output stage 422. The website management tool 306 may result in reduced computational costs and organization user time associated with maintaining compliance with various updates and changes made to technical standards across websites of the enterprise. Further, deployment of the presently disclosed techniques may provide improved efficiency and performance of implementing updates to portions of web code for display within various software architectures of the enterprise.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method comprising:
receiving a set of rules associated with a technical standard, wherein the set of rules comprise an update to the technical standard;
retrieving, from a code repository, a web code associated with a website;
identifying one or more portions of the web code that do not comply with at least one rule of the set of rules associated with the technical standard;
updating the one or more portions of the web code to comply with the set of rules; and
storing the one or more updated portions of the web code in the code repository.

2. The method of claim 1, wherein the technical standard comprises one or more search engine optimization guidelines, one or more web content accessibility guidelines, or a combination thereof.

3. The method of claim 1, wherein updating the one or more portions of the web code comprises applying the one or more rules to the one or more portions of the web code.

4. The method of claim 1, comprising:
receiving one or more additional portions of code from the code repository;
generating an additional rule based on an additional technical standard; and
storing the additional rule in a database with the set of rules.

5. The method of claim 1, comprising applying the set of rules to identify, via a website management tool, a particular feature of the portion of code within the web code.

6. The method of claim 5, wherein the particular feature comprises one or more tags, one or more structure parameters, one or more accessibility parameters, or a combination thereof.

7. The method of claim 1, wherein the set of rules are based on one or more technical standard definitions.

8. The method of claim 1, wherein the technical standard is stored in a technical standards repository.

9. The method of claim 1, comprising
identifying a browser associated with the web code associated with the website; and
tagging the web code based on a particular technical standard used by the identified browser.

10. The method of claim 1, comprising providing a graphical user interface (GUI) configured to display an updated website based on the updated portions of the web code.

11. A system, comprising:
processing circuitry; and
memory, accessible by the processing circuitry, the memory storing instructions that, when executed by the processing circuitry, cause the processing circuitry to perform operations comprising:
receiving a set of rules associated with a technical standard, wherein the set of rules comprise an update to the technical standard;
retrieving, from a code repository, a web code associated with a website;
identifying one or more portions of the web code that do not comply with at least one rule of the set of rules associated with the technical standard;
updating the one or more portions of the web code to comply with the set of rules; and
storing the one or more updated portions of the web code in the code repository.

12. The system of claim 11, wherein the processing circuitry performs operations comprising:
receiving one or more additional portions of code from the code repository;
generating an additional rule based on an additional technical standard; and
storing the additional rule in a database with the set of rules.

13. The system of claim 12, wherein the technical standard comprises one or more search engine optimization guidelines, one or more web content accessibility guidelines, or a combination thereof.

14. The system of claim 12, wherein updating the one or more portions of the web code comprises applying the one or more rules to the one or more portions of the web code.

15. The system of claim 11, wherein the processing circuitry performs operations comprising:
applying the set of rules to identify, via a website management tool, a particular feature of the portion of code within the web code.

16. The system of claim 15, wherein the particular feature comprises one or more tags, one or more structure parameters, one or more accessibility parameters, or a combination thereof.

17. A non-transitory computer-readable storage medium, comprising processor-executable routines that, when executed by a processor, cause the processor to perform operations comprising:
receiving a set of rules associated with a technical standard, wherein the set of rules comprise an update to the technical standard;
retrieving, from a code repository, a web code associated with a website;
identifying one or more portions of the web code that do not comply with at least one rule of the set of rules associated with the technical standard;
updating the one or more portions of the web code to comply with the set of rules; and
storing the one or more updated portions of the web code in the code repository.

18. The non-transitory computer-readable storage medium of claim 17, wherein the processor performs operations comprising:
receiving one or more additional portions of code from the code repository;
generating an additional rule based on an additional technical standard; and
storing the additional rule in a database with the set of rules.

19. The non-transitory computer-readable storage medium of claim 17, wherein the technical standard comprises one or more search engine optimization guidelines, one or more web content accessibility guidelines, or a combination thereof.

20. The non-transitory computer-readable storage medium of claim 19, wherein updating the one or more portions of the web code comprises applying the one or more rules to the one or more portions of the web code.
